(19) United States
(12) Patent Application Publication
(10) Pub. No.: US 2023/0322157 A1
(43) Pub. Date: Oct. 12, 2023

(54) VEHICLE REPORTING SYSTEM

(71) Applicant: Aharon KRISHEVSKI, Beit-Shemesh (IL)

(72) Inventor: Aharon KRISHEVSKI, Beit-Shemesh (IL)

(21) Appl. No.: 18/208,915

(22) Filed: Jun. 13, 2023

Related U.S. Application Data
(63) Continuation-in-part of application No. PCT/IL2021/051481, filed on Dec. 13, 2021.

(30) Foreign Application Priority Data
Dec. 14, 2020 (IL) 279430

(51) Int. Cl. B60Q 9/00; B62D 1/04; B60Q 1/00

(52) U.S. Cl. CPC B60Q 9/00; B62D 1/046; B60Q 1/0082

(57) ABSTRACT

A vehicle reporting system, including a plurality of electrodes disposed on a steering wheel, and a controller, for identifying which of the electrodes are electrically connected.

### CROSS-REFERENCE TO RELATED APPLICATIONS

This application is a continuation-in-part of International Application No. PCT/IL2021/051481, filed Dec. 13, 2021, which claims the benefit of priority from Israel Patent Application No. 279430, filed Dec. 14, 2020, the disclosures of which are incorporated herein by reference.

### TECHNICAL FIELD

The invention relates to the field of vehicle indications and to automotive lighting therefor.

### BACKGROUND

There is a lack for tools for ensuring that a driver holds the steering wheels by both hands.

There is a long felt need to provide a solution to the above-mentioned and other problems of the prior art.

### SUMMARY

A vehicle reporting system, including:
a plurality of electrodes disposed on a steering wheel; and
a controller, for identifying which of the electrodes are electrically connected.

### BRIEF DESCRIPTION OF THE DRAWINGS

FIG. 1 depicts a vehicle indication system according to one embodiment.

FIG. 2 is a conductance diagram of the electrodes of FIG. 1.

FIG. 3 depicts the inputs and outputs of the controller of FIG. 3.

FIG. 4 depicts the map of FIG. 3.

FIG. 5 depicts the vehicle and the result of the map of FIG. 4.

### DETAILED DESCRIPTION

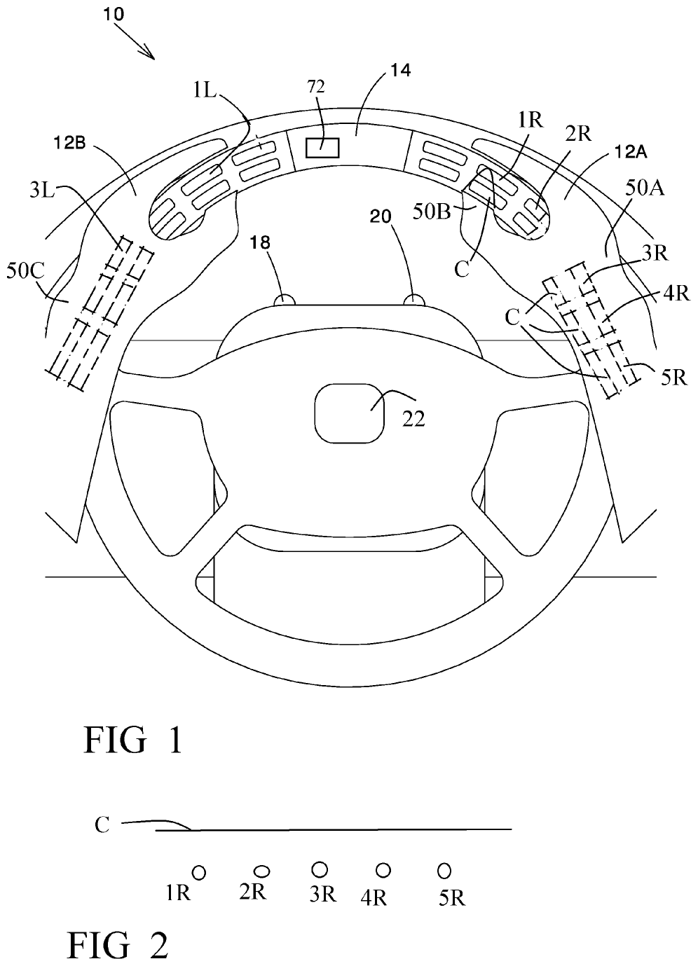

FIG. 1 is depicts a vehicle indication system according to one embodiment.

A vehicle indication system 10 includes a plurality of electrodes or other sensors, such as 1R, disposed on the vehicle's steering wheel 14 or on the cover thereof. The electrodes are configured to conduct therebetween by the driver's hand 12A disposed thereon via natural electrical conduction of the user's hand, or by physical pressure.

According to the example of FIG. 1, driver's hand 12A includes a zone 50A, which electrically connects between electrodes C (for common), 3R, 4R and 5R; and a zone 50B which electrically connects between electrodes “C” and “1R”.

Vehicle indication system 10 further includes a phone call receiver 72, especially for identifying written calls, such as SMS, Whatsapp, etc.

Vehicle indication system 10 further includes a controller 22 for identifying these electrical connections.

FIG. 2 is a conductance diagram of the electrodes of FIG. 1.

The “C” (being the common) electrodes are electrically connected one to the other, while electrodes “2R” and “5R” and others are not.

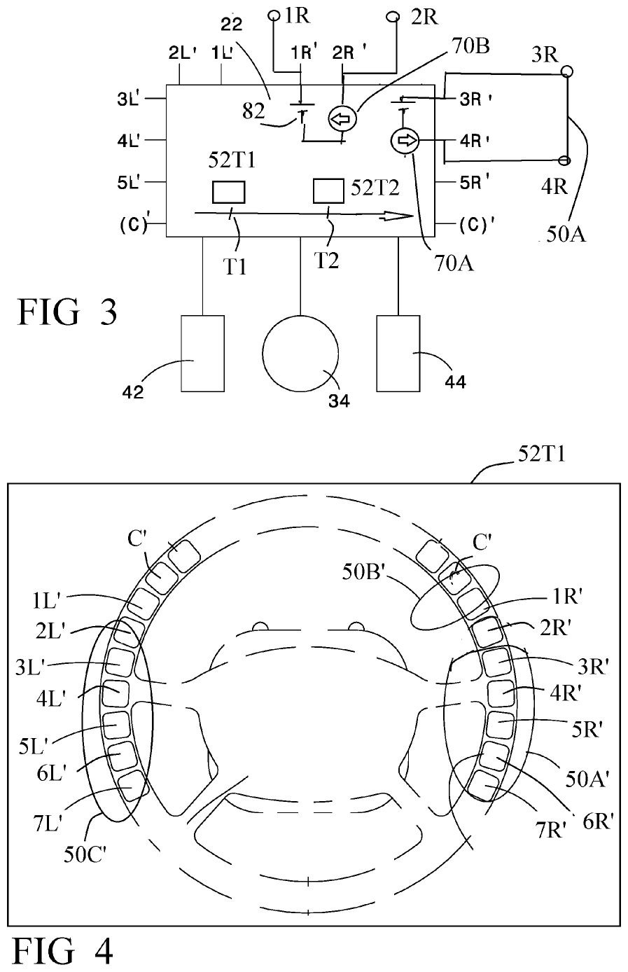

FIG. 3 depicts the inputs and outputs of the controller of FIG. 3.

All Electrodes constitute inputs to controller 22. For example, electrode 3R of FIG. 2 is connected to input 3R′ of controller 22, and electrode 4R of FIG. 2 is connected to input 4R′ of controller 22

Controller 22 is configured to identify the electrical connections between the electrodes, such as to identify the electrical conductance between electrodes 3R and 4R through zone 50A, being the user's right hand, by an internal conductance meter 70A disposed between input 3R′ and 4R′; and to identify the electrical cut between electrodes 1R and 2R by an internal conductance meter 70B disposed between input 1R′ and 2R′.

The identified electrical connections of time T1 are recorded into a map 52T1; the identified electrical connections of time T2 are recorded into a map 52T2, etc.

Controller 22 is programmed to collect maps 52T1, 52T2, etc. and their times T1, T2, etc. respectively into a memory 42.

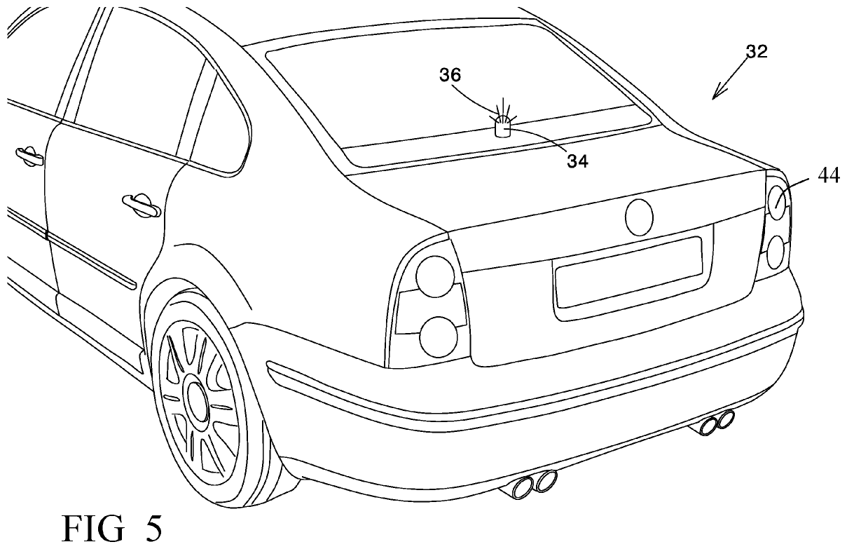

FIG. 4 depicts the map of FIG. 3.

The disposition of the hands of FIG. 1 in case of being on time T1 is diagnosed to produce map 52T1 whose content is that a zone 50A′ of map 52T1 constitutes electrical connection between inputs C′, 3R′, 4R′ and 5R; and a zone 50B′ constitutes electrical between inputs C′ and 1R′.

Map 52T1 is equivalent to the information that on time T1, zone 50A of the user's hands connects between inputs C, 3R, 4R and 5R; and zone 50B connects between inputs C and 1R.

FIG. 5 depicts the vehicle and the result of the map of FIG. 4.

In an (extreme) example that map 52T1 includes that none of the electrodes are connected, meaning that the driver does not hold steering wheel at all, controller 22 alerts by alerting means 34 (also in FIG. 3), which may be vocal and/or transmitting this information.

In the case of FIG. 1 that map 52T1 of FIG. 4 includes the information equivalent to electrodes “C” and “1R” of FIG. 1 being electrically connected, while electrodes “C” and “2R” are not connected one to the other, controller 22 identifies that zone 50B of FIG. 1 is which has connected electrodes “C” and “1R” being disposed, being the user's finger, meaning that the user indicates turning right instead of pressing the vehicle's conventional turning right indication button. Accordingly, controller 22 will blink the right indication lamp 44 of the vehicle. Thus, electrodes “C” and “1R” are utilized to a user interface.

Once identified that the user has removed hands from the steering wheel, and as well a call is attempting to be received, this is the most dangerous time to remove the hands from the steering wheel, since the removal is for using the phone.

The system reminds the driver to hold the steering wheel, turning on a red light when he does not

The system reports holding and non-holding of the steering wheel to the taxi company, LIBER, parents, etc.

The system produces, by distributing the data, rating of the driving qualities of different drivers, and thus each driver receives a score.

numeral 10 denotes the vehicle reporting system according to one embodiment of the invention;
14: steering wheel or a cover thereof;
18,20: bulbs indicating allowed and non-allowed holding;
32: vehicle;
34: alerting means, being visual and vocal and transmitter;
42: memory;
44: indication lamp;
50A,50B,50C: zones of the driver's hands;
50A′,50B′,50C′: zones of map 52T1; these zones are analyzed by controller 22 to represent zones 50A,50B,50C of the driver's hands disposed on steering wheel 14;
52T1, 52T2: diagnosis which may be presented by a map, of zones of the driver's hands disposed on steering wheel 14, for times T1,T2 respectively;
70A: internal conductance meter of controller 22, measuring electrical conductance between inputs 3R′ and 4R′;
70B: internal conductance meter of controller 22, measuring electrical conductance between inputs 1R′ and 2R′;
1R,2R,3R,4R,5R,6R,7R,1L,2L,3L,4L,5L,6L,7L,C: electrodes;
1R′,2R′,3R′,4R′,5R′,6R′,7R′,1L′,2L′,3L′,4L′,5L′,6L′,7L′,C′: inputs of controller 22;
T1,T2: times of measuring electrical conductance;
72: call receiver;

The reference numbers in the claims should not be interpreted as limiting the claims in any form.

What is claimed is:

1. A vehicle reporting system, comprising:
a plurality of sensors disposed on a steering wheel of the vehicle, the sensors being configured to sense disposition of user hands thereon; and
a controller, for identifying which of the sensors have sensed, and
for diagnosing the hands disposition on the steering wheel corresponding to the identified sensing sensors.

2. The vehicle reporting system according to claim 1, further comprising:
a call receiver, for identifying call received, wherein said controller is further for diagnosing said hands disposition on the steering wheel combined with said identified received calls.

3. The vehicle reporting system according to claim 1, further comprising:
reporting means,
wherein the controller is configured for selecting events according to the diagnosis, and for operating the reporting means to report the selected events.

4. The vehicle reporting system according to claim 3, wherein the events comprise insufficient holding of the steering wheel.

5. The vehicle indication system according to claim 3, wherein the reporting means comprise alerting means, for alerting unsafe holding of the steering wheel.

6. The vehicle indication system according to claim 2, further comprising alerting means, for alerting unsafe holding of the steering wheel combined with receipt of call.

7. The vehicle reporting system according to claim 1, wherein the diagnosis comprises applying the hands disposition on the steering wheel to function as a user interface via the diagnosing.

8. The vehicle reporting system according to claim 7, wherein the user interface comprises right and left turning indication user interface diagnosed by the identified electrically connected sensors by a user's finger.

9. The vehicle reporting system according to claim 1, further comprising:
a memory (42), for comparing the diagnosis to history of the hands disposition.

10. The vehicle reporting system according to claim 1, wherein the identifying and the diagnosing are as a function of time.
